(19) United States
(12) Patent Application Publication
(10) Pub. No.: US 2013/0213267 A1
(43) Pub. Date: Aug. 22, 2013

(54) Composition Comprising Polymers and Metal Atoms or Ions and Use Thereof

(71) Applicant: Evonik Goldschmidt GmbH, (US)

(72) Inventors: Michael Fiedel, Essen (DE); Michael Ferenz, Essen (DE); Wilfried Knott, Essen (DE); Ingrid Eißmann, Gelsenkirchen (DE); Susann Wiechers, Essen (DE)

(73) Assignee: Evonik Goldschmidt GmbH, Essen (DE)

(21) Appl. No.: 13/771,921

(22) Filed: Feb. 20, 2013

(30) Foreign Application Priority Data
Feb. 20, 2012 (DE) 10 2012 202 527.8

(51) Int. Cl. C09K 3/00

(52) U.S. Cl. CPC C09K 3/00
USPC 106/403

(57) ABSTRACT

The present invention relates to compositions comprising the components A, a polymer obtainable by the reaction in the sense of a hydrosilylation of a siloxane having SiH functions and vinyl functions with a further unsaturated compound, and D, metal atoms or ions, not equal to silicon, a process for the preparation of these compositions, and the use of the compositions for producing antifoams or as antifoams of liquids, and also for suppressing or reducing the foam formation of foaming liquids, and also for foam destabilization.

The present application claims priority from German Patent Application No. DE 10 2012 202 527.8 filed on Feb. 20, 2012, the disclosure of which is incorporated herein by reference in its entirety.

### 1. FIELD OF THE INVENTION

The present invention relates to compositions comprising the components A, a polymer obtainable by reaction in the sense of a hydrosilylation of a siloxane having SiH functions and vinyl functions with an unsaturated compound, and D, metal atoms or ions, not equal to silicon, a process for the preparation of these compositions, and the use of the compositions for producing antifoams or as antifoams of liquids, and also for suppressing or reducing the foam formation of foaming liquids, and also for foam destabilization.

It is noted that citation or identification of any document in this application is not an admission that such document is available as prior art to the present invention.

With their widely adjustable surfactant behaviour, silicon-carbon linked, organomodified siloxanes, specifically polyethersiloxanes, represent an industrially very important substance class. The established way of producing these substances is the platinum-metal-catalysed addition reaction of siloxanes carrying SiH groups onto olefinically functionalized compounds (hydrosilylation). Often used olefinically functionalized compounds are, for example, allyl polyethers. The hydrosilylation can take place in the presence of a solvent or without a solvent. Furthermore, the hydrosilylation can also be carried out in the presence of water, as the patent specification EP 1754740 discloses. It describes the preparation of aqueous solutions by the reaction of SiH-containing siloxanes or silanes with compounds which have at least one double bond in the presence of water as reaction medium. The SiH-containing siloxanes described therein contain no further functional groups, e.g. vinyl groups, meaning that the resulting polyethersiloxanes are uncrosslinked and have the performance known in the prior art. Moreover, this method is exclusively suitable for preparing water-soluble products and is thus limited.

The topology of organosiloxanes influences their properties considerably. This is evident from a very wide variety of applications, although it is often difficult or impossible to predict to what extent the structural properties influence the performance of a siloxane polymer. As a rule, it requires an experiment in order to correlate structural and material properties with one another.

Siloxanes whose polymer backbone is branched and/or which are crosslinked have a special topology. Polymeric networks differ not only in the crosslinking density, but also with regard to the regularity of chemical structure and chain length between the crosslinking sites and also in the superstructure. This results in great product diversity and, by adjusting these parameters, it is possible to influence the properties of organosiloxanes in a targeted manner.

Siloxane elastomers are of great commercial importance. They are accessible via curable masses, which are generally 2 component systems, where one component consists of terminally vinyl-functional siloxanes and the other consists of siloxanes carrying lateral SiH groups and are subsequently cured under catalytic conditions.

Classic two-component systems for producing silicone elastomers ate adequately known and commercially available for a broad application spectrum. Examples which may be mentioned are ELASTOSIL® P 7684-40 A/B (Wacker Chemie, Burghausen) and Albisil® A-1129 A&B and Albisil® A-3018 A&B (both Hanse Chemie, Geesthacht).

The preparation of siloxanes carrying terminal vinyl groups is likewise adequately known to the person skilled in the art and can be carried out inter alia by equilibrating tetramethyldivinylsiloxane with cyclic siloxanes such as octomethylcyclotetrasiloxane or silanol-terminated siloxanes. Such an equilibrium is described inter alia in T. Smith—Origin of the self-reinforcement in poly(dimethylsiloxane) bimodal networks (Rubber Chemistry and Technology, 1990, 63, 2, p. 256). FP 1319680 describes the equilibration of vinyldimethyl-terminated siloxanes with silanol-terminated siloxanes with NaOH (page 5, example 3).

WO 2010/080755 describes the preparation of polyethersiloxane elastomers for the storage and targeted release of care or medically effective substances (so-called drug delivery systems) by reacting lateral SiH siloxanes with mono- and diallyl polyethers in hydrophobic media and downstream mechanical trituration to give smaller particles, and subsequent dispersion.

One disadvantage of this crosslinking principle lies firstly in the limited and cost intensive accessibility of the organic diallyl polyethers and secondly in the pregiven topology resulting therefrom. Thus, the siloxane backbone is interrupted again and again by polyether segments, the individual siloxane chains being linked with one another via polyether segments.

As a rule, the siloxane character is more marked the less modified the siloxane along the backbone. This is advantageous for many applications in which a high siloxane fraction is desired.

It is clear from the explanation above that hitherto the simple access to high molecular weight, crosslinked organosiloxanes is only limited, in particular, the resulting high molecular weight gels and elastomers have to be converted to a handleable form, which entails costs, or they are prepared using a solvent.

If, as mentioned above, crosslinked siloxanes are prepared by reacting SiH-containing siloxanes with alpha, omega-divinylsiloxanes, then, on account of the low substantivity of the alpha, omega-divinylsiloxanes, it has to be expected that some of this material is not incorporated by reaction into the network and therefore remains as migratable material within the product. In many applications, this constitutes a major disadvantage since residual siloxanes are carried on the surface where, for example, they can adversely affect the application properties. This would be present as a result of the so-called sweating out of low molecular weight constituents from the polymer matrix.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right to disclaim, and hereby disclose a disclaimer of, any previously described product, method of making the product, or process of using the product.

### SUMMARY OF THE INVENTION

It was therefore an object of the present invention to prepare crosslinked organomodified siloxanes which overcome at least one of the disadvantages described above. In particular, the aim was to provide a more economically attractive and technically easy-to-realize access to crosslinked siloxanes which preferably, moreover, makes it possible to easily adjust the profile of properties of the high molecular weight fractions in a targeted manner.

Surprisingly, it has been found that compositions comprising the components A and D and optionally B and/or C, as defined below, achieve this object.

The present invention therefore provides compositions comprising the components A and D and optionally B and/or C as described in the claims.

The present invention further provides a process for the preparation of compositions according to the invention which is characterized in that at least one compound of the formula (I) is reacted with compounds of the formula (I) and/or with other compounds C which have a C—C multiple bond and do not correspond to formula (I) under hydrosilylating conditions.

Process for the preparation of compositions comprising the components A and D and optionally B and/or compounds C in which a compound of the formula (I) and optionally a compound of the formula (II) is optionally reacted with unsaturated compounds which contain one or more multiple bonds under hydrosilylating conditions and in the presence of a catalyst catalysing the hydrosilylation.

The present invention likewise provides the use of the compositions according to the invention and also the products of the process according to the invention for producing and as antifoams of liquids, and also for suppressing or reducing the foam formation of foaming liquids, and also for foam destabilization.

The compositions according to the invention have the advantage that they are able, with high effectiveness, to defoam liquids. The high effectiveness refers here to a shortened foam disintegration time.

A further advantage of the compositions according to the invention consists in the fact that they have a considerably lowered silicon weight fraction compared to previous antifoams on a purely siloxane basis.

It is an advantage of the process according to the invention to obtain the compositions according to the invention directly during their preparation in an easy-to-handle form. These handleable forms are, for example, emulsions or dispersions. It is particularly advantageous that even high molecular weight gel-like to solid products are easy to handle and stirrable in emulsion.

It is a further advantage of the process according to the invention that the products which have been prepared in emulsion are easy to formulate and do not subsequently have to be emulsified or dispersed in a costly manner. These subsequent formulations are often destructive with regard to the chemical structure, i.e. the polymers are altered in their structural identity in a manner that could not automatically be predicted. Modifications of this type, which arise e.g. as a result of increased shearing, do not form part of this invention.

### BRIEF DESCRIPTION OF THE DRAWINGS

FIG. 1 shows a schematic design of an apparatus for carrying out defoaming experiments, the so-called frit test.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

The compositions and processes for the preparation of the compositions, and also the use thereof, are described below by way of example without intending to limit the invention to these exemplary embodiments. Where ranges, general formulae or compound classes are given below, then these are intended to encompass not only the corresponding ranges or groups of compounds explicitly mentioned, but also all part ranges and part groups of compounds which can be obtained by removing individual values (ranges) or compounds. Where documents are cited within the context of the present description, then their contents are to be deemed as belonging in their entirety to the disclosure of the present invention. Where content data (ppm or %) are given above or below, then, unless stated otherwise, this data is in % by weight or ppm by weight (wppm). For compositions, the content data refers to the overall composition unless stated otherwise. Where averages are given below, then unless stated otherwise these are numerical averages. Where molar masses are used, then, unless expressly noted otherwise, these are weight-average molar masses Mw with the unit g/mol. Where measurement values are given below, then these measurement values were ascertained, unless stated otherwise, at a pressure of 1013.25 hPa and a temperature of 23° C.

The definitions below sometimes include other terms which are used equivalently and synonymously to the defined term.

In connection with this invention, the word fragment “poly” includes not only exclusively compounds with at least 3 repeat units of one or more monomers in the molecule, but in particular also those compositions of compounds which have a molecular weight distribution and here have an average molecular weight of at least 200 g/mol. This definition takes into consideration the fact that it is customary in the technical field under consideration to refer to such compounds as polymers even if they do not appear to satisfy a polymer definition analogously to OECD or REACH Guidelines.

The various fragments in the formulae (I), (II), (III), and (IV) below can be in random distribution. Random distributions can have a blockwise structure with any desired number of blocks and any desired sequence or they can be subject to a randomized distribution, they may also have an alternating structure or else form a gradient via the chain, in particular they can also form all mixed forms in which optionally groups of different distributions can follow one another. The formulae (I), (II), (III) and (IV) describe polymers which have a molecular weight distribution. Consequently, the indices represent the numerical average over all monomer units.

The index numbers a, b, c, d, e, f, g, f, i, j, k, l, m, n, o, p, q and r used in the formulae, and also the value ranges of the stated indices can be understood to be average values of the possible random distribution of the actual structures present and/or mixtures thereof. This is the case also for structural formulae as such reproduced exactly per se, such as, for example, for formula (I), (II), (III) and (IV).

The compositions according to the invention are characterized in that they contain the components A and D, with
A comprising a polymer obtainable by reaction in the sense of a hydrosdvlation of compounds of the formula (I)

MₐM^{v}_{b}M^{H}_{c}D_{d}D^{H}ₑD^{v}_{f}T_{g}Qₕ formula (I)
with
   M=[R¹₃SiO_{1/2}]
   M^{V}=[R³R¹₂SiO_{1/2}]
   M^{H}=[R¹₂SiHO_{1/2}]
   D=[R¹₂SiO_{2/2}]
   D^{H}=[R¹SiH_{2/2}]
   D^{V}=[R³R¹SiO_{2/2}]
   T=[R¹SiO_{3/2}]
   Q=[SiO_{4/2}]
   a=0 to 42, preferably 0 to 22, particularly preferably greater than 0 to 2,
   b=0 to 42, preferably equal to or greater than 1 to 22, particularly preferably greater than 1 to less than 2,
   c=0 to 42, preferably 0 to 22, particularly preferably 0,
   d=5 to 600, preferably 10 to 400, more preferably 20 to 300, particularly preferably 50 to 200,
   e=0 to 50, preferably greater than 0 to 25, more preferably 0.5 to 10, particularly preferably 0.7 to 1.5,
   f=0 to 50, preferably 0 to 25, particularly preferably 0,
   g=0 to 20, preferably greater than 0 to 10, particularly preferably 1 to 5,
   h=0 to 20, preferably 0 to 10, particularly preferably 0,
   with the proviso that the following conditions are satisfied
   a+b+c is greater than or equal to 2,
   b+f is greater than 0, preferably greater than or equal to 1.2 and less than 2,
   c+e is greater than 0, preferably greater than 0.8, more preferably greater than 1 to 8, particularly preferably from 1.2 to less than 6 and 0.24*(a+b+c+d+c+f+g) is greater than
   R¹, independently of one another are identical or different alkyl radicals having 1 to 30 carbon atoms, or identical or different aryl radicals having 6 to 30 carbon atoms or identical or different radicals —OH or —OR², preferably methyl, phenyl, —OH or —OR², in particular methyl or phenyl,
   R², independently of one another, are identical or different alkyl radicals having 1 to 12 carbon atoms, or identical or different aryl radicals having 6 to 12 carbon atoms, preferably methyl, ethyl, n-propyl, isopropyl, n-butyl, sec-butyl, isobutyl, phenyl, in particular methyl or ethyl,
   R³, independently of one another, are identical or different organic radicals with a terminal C—C double bond or a terminal or internal C—C triple bond, preferably organic radicals with a terminal double bond, in particular vinyl (i.e. —CH═CH₂) or allyl (i.e. —CH₂CH═CH₂),
   with compounds of the formula (I) and/or with other compounds C which have a C—C multiple bond and do not correspond to formula (I), and
D is metal atoms and/or ions of the platinum group, preferably platinum, rhodium and ruthenium atoms, in particular platinum atoms.

The compounds of the formula (I) can be referred to as self-crosslinking siloxanes. They are characterized in that, besides SiH functions, they have multiple bonds accessible to the hydrosilylation and therefore two or more compounds of the formula (I) can react with one another in the course of a hydrosilylation.

The compositions according to the invention can contain, as component A, exclusively or as well as other polymers, a polymer which is obtainable by reaction in the sense of a hydrosilylation of compounds of the formula (I) and compounds of the formula (II)

MᵢM^{H}ⱼDₖD^{H}ₗTₘQₙ formula (II)
with
   i=0 to 34, preferably 0 to 18, particularly preferably greater than 0 to 2,
   j=0 to 34, preferably 0 to 18, particularly preferably greater than 0 to 2,
   k=5 to 600, preferably 10 to 400, more preferably 20 to 200, particularly preferably 50 to 150,
   l=0 to 50, preferably greater than 0 to 35, more preferably 1 to 26, particularly preferably greater than 1 to 10,
   m=0 to 16, preferably 0 to 8, in particular 0,
   n=0 to 16, preferably 0 to 8, in particular 0,
   i+j is greater than or equal to 2 and
   j+l is greater than or equal to 2.

Preferably, the compositions have a component A which contains a polymer obtainable by reaction in the sense of a hydrosilylation of compounds of the formula (I) with one or more unsaturated compounds C. Preferably, the compositions according to the invention have a component A which contains a polymer obtainable by reaction in the sense of a hydrosilylation of compounds of the formula (I) with a compound of the formula (II) and one or more unsaturated compounds C.

It may be advantageous if the compositions according to the invention contain a component B obtainable by reaction in the sense of a hydrosilylation of compounds of the formula (II), as defined above and unsaturated compounds C.

The compositions according to the invention can comprise one or more compounds C, these can be added subsequently to the composition or remain as unreacted reactant in the composition during the preparation of the composition.

The aforementioned compounds C are preferably olefins or polyethers which have one or more carbon-carbon multiple bonds, preferably polyethers which have one or more carbon-carbon multiple bonds.

Preferred olefins are olefins with terminal double bonds, e.g. alpha-olefins, alpha, omega-olefins, allyl-group-carrying mono- and polyols or allyl-group-carrying aromatics. Particularly preferred olefins are ethene, ethyne, propene, 1-butene, 1-hexene, 1-dodecene, 1-hexadecene, 1,3-butadiene, 1,7-octadiene, 1,9-decadiene, styrene, eugenol, allylphenol, undecylenic acid methyl ester, allyl alcohol, allyloxyethanol, 1-hexen 5-ol, allylamine, propargyl alcohol, propargyl chloride, propargylamine or 1,4-butynediol.

Preferred polyethers with one or more multiple bonds are, for example, allyl-functional polyethers or 1,4-butynediol-started polyethers. Particularly preferred polyethers which have carbon-carbon multiple bonds are preferably those of the formula (III),

CH₂═CHCH₂O(C₂H₄O)ₒ(C₂H₃(CH₃)O)ₚ(C₂H₃(C₂H₅)O)_{q}(C₂H₃(Ph)O)ᵣR⁴ formula (III)

with
R⁴, independently of one another, are identical or different organic radicals which carry no multiple bond accessible to the hydrosilylation, or hydrogen, preferably hydrogen, alkyl radicals or carboxy radicals, particularly preferably hydrogen, methyl, butyl or acetyl, especially preferably hydrogen,
o=0 to 200, preferably greater than 0 to 150, particularly preferably greater than or equal to 3 up to 150, especially preferably equal to or greater than 3 up to 100,
p=0 to 200, preferably 0 to 150, particularly preferably greater than 0 to 100, in particular equal to 1 to 50,
q=0 or greater than 0 to 100, preferably 0 or greater than 0 to 30, particularly preferably 0 or greater than 0 to 1, in particular 0,
r=0 or greater than 0 to 100, preferably 0 or greater than 0 to 30, particularly preferably 0 or greater than 0 to 1, in particular 0,
and the conditions
   o+p+q+r is greater than 3, preferably p is greater than 0.

It may be advantageous if the indices of the polyether according to formula (III) satisfy the following conditions: o is greater than 0, preferably o is greater than p+q+r, particularly preferably o is greater than p, very particularly preferably o is greater than 1.5*p. The index p of the polyether according to formula (III) is preferably greater than 0, in the case of p=0, o is at least 4, preferably at least 8; in the case of p=0 and q+r is equal to or greater than 2, o is at least 2*(q+r). If q+r is less than 2 and p is greater than 0t, then o is greater than 4*p.

Very particularly preferred polyethers are, for example:

CH₂═CHCH₂O(C₂H₄O)₈(CH₃(CH₃)O)₈H

CH₂═CHCH₂O(C₂H₂O)₈(C₂H₃(CH₃)O)₈CH₃

CH₂═CHCH₂O(C₂H₄O)₈(C₂H₃(CH₃)O)₈C(O)CH₃

CH₂═CHCH₂O(C₂H₄O)₈(C₂H₃(Ph)O)₃H

Further preferred polyethers are, for example:

CH₂═CHCH₂O(C₂H₄O)₂₀(C₂H₃(CH₃)O)_{4.5}H

CH₂═CHCH₂O(C₂H₄O)₂₅(C₂H₃(CH₃)O)_{4.5}H

CH₂═CHCH₂O(C₂H₄O)₈H

CH₂═CHCH₂O(C₂H₄O)₂₀(C₂H₃(CH₃)O)_{4.5}Me

CH₂═CHCH₂O(C₂H₄O)₂₆(C₂H₃(CH₃)O)_{4.5}Me

CH₂═CHCH₂O(C₂H₄O)₈Me

CH₂═CHCH₂O(C₂H₄O)₂₀(C₂H₃(CH₃)O)_{4.5}acetyl

CH₂═CHCH₂O(C₂H₄O)₂₆(C₂H₃(CH₃)O)_{4.4} acetyl

CH₂═CHCH₂O(C₂H₄O)₈acetyl

CH₂═CHCH₂O(C₂H₄O)₈(C₂H₃(Ph)O)₃H

CH₂═CHCH₂O(C₂H₄O)₈(C₂H₃(Ph)O)₂H

Polyethers of this type are commercially available in a great variety, e.g. under the trade names Pluriol® (BASF) or Polyglycol AM® (Clariant).

The compositions according to the invention preferably have the component A with a fraction of from 1 to 90% by weight, preferably greater
than 1 to 30% by weight, preferably 1 to 15% by weight,
the component B with a fraction of from 0 to 70% by weight, preferably greater than 0 to 40% by weight, preferably 1 to 30% by weight,
the compounds C with a fraction of from 0 to 95% by weight, preferably 5 to 90% by weight, preferably 10 to less than 90% by weight and
the component D with a fraction of greater than 0 to 50 ppm by weight,
in each case based on the mass of the total composition.

Preferably, the compositions have

the component A with a fraction of 1 to 15% by weight,

the component B with a fraction of from 1 to 30% by weight,

the compounds C with a fraction of from 10 to less than 90% by weight and

the component D with a fraction of greater than 0 to 50 ppm by weight, in each case based on the mass of the total composition.

In the compositions according to the invention, the polymer of component A is present to more than 90% by weight, based on the components A with a weight-average molar mass of less than 2 500 000 g/mol.

In the compositions according to the invention, the component B is present to more than 90% by weight, based on the component B with a weight-average molar mass of up to 1 000 000 g/mol. Such a component B is preferably present in the composition with less than 5% by weight, based on the total composition.

Preferred compositions are characterized in that the component
A is present to more than 90% by weight, based on the components A, polymers with a weight-average molar mass of less than 2 500 000 g/mol and the component
B is present to more than 90% by weight, based on the component B with a weight-average molar mass of up to 1 000 000 g/mol and the component B is present in the composition with less than 5% by weight, based on the total composition.

The compositions according to the invention are preferably liquid at 20° C. and 1013 mbar. Within the context of the invention, liquid substances are homogeneous and/or heterogeneous mixtures which have a viscosity of less than 120 Pa*s, preferably less than 100 Pas and particularly preferably less than 10 Pas at room temperature, preferably at 20° C. and atmospheric pressure (1013 mbar). Accordingly, preferred compositions preferably have a corresponding viscosity, determined as stated in the examples.

The compositions according to the invention preferably have a content of less than 25% by weight, preferably less than 20% by weight, particularly preferably less than 15%, and very particularly preferably from 0.01 to 10% by weight, of silicon based on the sum of the masses of components A, B And D and compound C of the composition according to the invention.

The content of metal atoms and/or ions of the platinum group in the composition according to the invention is preferably greater than 0 to 50 wppm (ppm by mass), preferably 1 to 40 wppm, particularly preferably 3 to 30 wppm, very particularly preferably 5 to 20 wppm and especially preferably 8 to 10 wppm, based on the total mass of the composition. Preferably, platinum, ruthenium and/or rhodium are present in the composition in these concentrations.

The compositions according to the invention are preferably colourless or slightly yellowish and can be clear or cloudy.

The compositions according to the invention can optionally comprise further additives. Preferred additives are aliphatic and/or aromatic oils, solvents, water and/or emulsifiers. Particularly preferred additives are water and emulsifiers.

Preferred solvents are e.g. alcohols and aliphatic hydrocarbons. Preferred alcohols are e.g. methanol, ethanol, ethylene glycol, n-propanol, isopropanol, 1,2-propylene glycol, 1,3-propylene glycol, n-butanol, 2-butanol and tert-butanol. Preferred hydrocarbons are in particular hydrocarbons with a boiling point at atmospheric pressure (1013 mbar) of less than 250° C.

Within the context of the invention, emulsifiers are substances which are able to form an emulsion. This emulsion can be e.g. a O/W, W/O or multiphase emulsion. The emulsifier used or the emulsifier system can be selected e.g. from the groups of the nonionic, anionic, cationic or amphoteric emulsifiers or mixtures thereof.

Examples of suitable anionic emulsifiers are e.g. alkali metal soaps, alkylarylsulphonates (e.g. sodium dodecylbenzylsulphonate), long-chain fatty alcohol sulphates, sulphated monoglycerides, sulphated esters, sulphated-ethoxylated alcohols, sulphosuccinicates, phosphate esters, alkyl sarcosinates. Examples of suitable cationic emulsifiers are inter alia quaternary ammonium salts, sulphonium salts, phosphonium salts or alkylamine salts. Examples of nonionic emulsifiers are e.g. fatty alcohol alkoxylates, fatty acid alkoxylates, alkoxylates based on amines or amides, glycerols or polyglycerol alkoxylates, alkoxylates of sorbitol and further sugar alkoxylates. Commercially available nonionic emulsifiers are available e.g. under the trade names Breij® (Uniqema, ICI Surfactants), Synperonic® (Croda) or Tergitol® (Dow Chemical). Examples of amphoteric emulsifiers are e.g. betaines or alkylamino acid salts.

Suitable emulsifiers can also be solids, so-called Pickering emulsifiers. Thus, for example, EP 2067811 (page 15, example 1) discloses the use of nanoparticulate SiO₂ as suitable emulsifier for the silicone acrylate Tego RC 726 (Evonik (Goldschmidt GmbH, Essen).

Preferred emulsifiers are e.g. TEGO® Alkanol TD6 from Evonik Industries AG, Genapol® T800 (Clariant), Synperonic® PE F 108 from Croda.

Preferred use amounts of emulsifiers are preferably from 0.1 to 49% by weight, preferably 0.5 to 20% by weight, particularly preferably from 1 to 15% by weight, based on the composition.

In a further embodiment, it may be advantageous if the compositions according to the invention have no water and emulsifiers.

The compositions according to the invention optionally comprise compounds characterized by the part structure of the formula (V).

CH₃—CH═CH— formula (V)

Preferred compounds comprising the part structure of the formula (V) are polyethers of the formula (IV)

CH₃—CH═CH—O(C₂H₄O)ₒ(C₂H₃(CH₃)O)ₚ(C₂H₃(C₂H₅)O)_{q}(C₂H₃(Pb)O)ᵣR⁴ formula (IV)
where the indices and the radical R⁴ are as defined in formula (III). The preferred ranges given for formula (III) apply equally also to the compounds of the formula (IV).

The compounds of the formulae (IV) and/or (V) can additionally be added to the composition or are formed e.g. as a result of rearrangements at C—C multiple bonds in the course of the preparation of the composition, in particular during the reaction under hydrosilylating conditions.

The fraction of compounds which have a part structure of the formula (V), preferably compounds of the formula (IV) in the composition according to the invention is preferably from 0.0001 to 25% by weight, preferably from 0.01 to 20% by weight.

It may be advantageous if the composition according to the invention has no compounds which have a part structure of the formula (V), or the fraction is so low that it cannot be detected analytically

The compositions according to the invention comprising the components A and D and optionally B and/or compound C can be obtained in different ways. Preferably, the preparation of the polymers according to the invention takes place by the process according to the invention described below.

The process according to the invention for the preparation of compositions according to the invention is characterized in that at least one compound of the formula (I) are reacted with compounds of the formula (I) and/or with other compounds C which have a C—C double bond and do not correspond to formula (I), under hydrosilylating conditions and in the presence of a catalyst catalysing the hydrosilylation.

Preferably, in the process according to the invention, at least one compound of the formula (I) and at least one compound of the formula (II) is reacted with at least one unsaturated compound C which contains one or more C—C multiple bonds under hydrosilylating conditions.

In general, the reactants can be added to the reaction vessel in any desired order.

The process according to the invention can be carried out with the addition of water. The process according to the invention can be carried out in the presence of one or more solvents. The process according to the invention can be carried out with the addition of one or more emulsifiers. Preferably, in the process according to the invention, the hydrosilylating reaction is carried out with the addition of water, optionally a solvent and optionally with the addition of emulsifiers. The process according to the invention is particularly preferably carried out in an oil-in-water (O/W) emulsion.

Suitable solvents are, for example, those which do not inhibit or disturb the hydrosilylation reaction. Suitable solvents are, for example, aromatic and aliphatic hydrocarbons, linear or cyclic ethers, alcohols, esters or mixtures of different solvents. Suitable solvents are also many emollients used in cosmetics, e.g. Tegosoft® P from Evonik Industries AG.

In a further embodiment, it may be advantageous to prepare the compositions according to the invention without water and emulsifiers.

The unsaturated compounds C that can be reacted in the sense of a hydrosilylation are preferably water-soluble compounds, whereas the compounds of the formula (I) and formula (II) are preferably not water-soluble.

To prepare emulsions, the various reactants of the hydrosilylation reaction can be mixed together, it being possible for the order of the addition and the selected addition time points to be different here. It may e.g. be useful to only emulsify part of the reactants and to meter in the other reactants afterwards.

The individual reactants can likewise be added in portions at different times of the emulsification. This procedure is adequately known to the person skilled in the art. The theoretical principles for preparing emulsions are described inter alia in Tharwat F. Tadros—“Emulsion Science and Technology” (Wiley-VCH Verlag GmbH & Co. KGaA; edition: 1^{st} Edition; 18 Mar. 2009; ISBN-10: 3527325255). Emulsification methods are also listed in ES 4,476,282 and US 2001/0031792, which are hereby incorporated in their entirety into the scope of protection of the present invention. The cited references also contain details relating to mixing the reactants; this can take place in different ways, it being possible to use a wide variety of stirring units.

The mixing operation can be carried out as a batch process (one-pot process), semi-continuous process or continuous process.

When carrying out the process according to the invention, the reaction components are preferably supplied to the reaction vessel, with the proviso that, prior to starting to add the catalyst, at least one aliquot of the compound of the formula (I) or at least one aliquot of a mixture comprising the compound (II) and an unsaturated compound C is present in the reaction mixture in the reaction vessel.

Preferably, the compounds of the formula (I), optionally together with compounds of the formula (II), preferably all of the compounds of the formulae (I) and optionally (II) are introduced into the reaction vessel, brought to the reaction temperature and then admixed with a hydrosilylation catalyst. The compounds C can then be added.

In another embodiment, it may be advantageous to add the compounds C if appropriate together with compounds of the formula (II) even before the addition of the catalyst.

In another embodiment, it may be advantageous to introduce the compounds C and to meter in the compounds of the formula (I) and optionally (II) in succession or together.

The metering order can be varied within a wide scope. In some cases, it is advantageous to meter in reactants simultaneously. Moreover, the individual reactants can be premixed and supplied as a mixture to the reaction mixture. It is also possible to add certain reactants in portions to different phases of the reaction. The manner in which the reaction is carried out can significantly influence the composition of the product.

The supply of the reactants and optionally further additives can take place in portions or metered over the time, and also in mixed forms of these supply options.

The process according to the invention can be carried out either in a batch operation or else continuously, or else in conceivable mixed-operation runs. Preferably, the process according to the invention is carried out in a batch operation.

The hydrosilylating reaction of the process according to the invention can be carried out e.g. as described in EP1520870.

The process according to the invention is preferably carried out such that the conversion with regard to the Si—H functions used or with regard to the C—C multiple bonds of the reactants used is complete or as complete as possible. Preferably, the conversion is greater than 99%, preferably greater than 99.9%, particularly preferably greater than 99.999 and very particularly preferably greater than 99.999999%. The corresponding conversion can be determined by detecting the remaining SiH groups or the unreacted C—C multiple bonds.

Catalysts which can be used for the hydrosilylation are metal catalysts, preferably precious metal catalysts of the platinum group, preferably platinum-, rhodium- or ruthenium-containing catalysts, in particular complexes which are known to the person skilled in the art as hydrosilylating-active catalysts, e.g. platinum compounds such as, for example, hexachloroplatinic acid, (NH₃)₂PtCl₂, cis-platinum, bis(cyclooctene)platinum dichloride, carbo platinum, platinum(0)-(divinyltetramethyldisiloxane) complexes, so-called Karstedt catalysts, or else platinum(0) complexes complexed with different olefins. Of suitability in principle are furthermore rhodium and ruthenium compounds, such as, for example, tris(triphenylphosphine)rhodium(I) chloride or tris(triphenylphosphine)rhuthenium(II) dichloride. Catalysts preferred in the course of the process according to the invention are platinum(0) complexes. Particular preference is given to Karstedt catalysts or so-called WK catalysts, which can be prepared according to EP1520870. Suitable and preferred conditions for the hydrosilylation reaction are described e.g. in EP 1520870 (application examples 1, 4-7); these are hereby incorporated by reference and form part of the disclosure of the present invention.

The person skilled in the art is aware that the catalyst has to be selected such that it is not inhibited or inactivated by the individual components of the reaction used, preference being given to catalyst/reactant mixtures which do not influence the properties and also the reactivity of the catalyst.

The catalysts are preferably used in an amount of from 0.1 to 1000 wppm, more preferably 1 to 100 wppm, particularly preferably 5 to 30 wppm and especially preferably 8 to 15 wppm, based on the mass of the total mixture of the hydrosilylation reaction.

The compositions according to the invention or the compositions prepared according to the invention can be used for producing antifoams or as antifoams liquids.

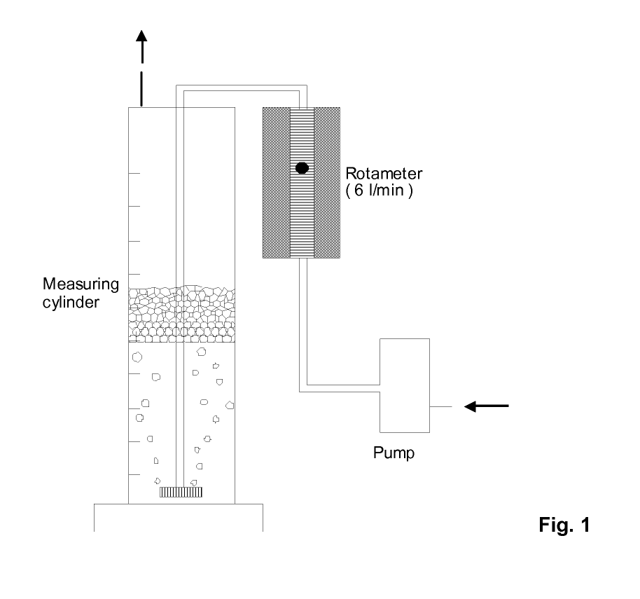

The present invention is explained in more detail by reference to the diagram FIG. 1 without intending to limit the invention, the scope of application of which arises from the entire description and the claims, to the embodiment specified in the diagram. FIG. 1 shows a schematic design of an apparatus for carrying out defoaming experiments, the so-called frit test.

The examples given below describe the present invention by way of example without any intention of limiting the invention, the scope of application of which arises from the entire description and the claims, to the embodiments specified in the examples.

### WORKING EXAMPLES

### General Methods and Materials

Viscosity—Determination of the Viscosity by Means of a Spindle Viscosimeter Model Brookfield LV-DV-I+

Brookfield viscosimeters are rotary viscosimeters with defined spindle sets as rotary bodies. The rotary bodies used were a LV spindle set. On account of the temperature dependency of the viscosity, the temperatures of viscosimeter and measuring liquid were kept precisely constant at +/−0.5° C. at 20° C. during the measurement. Further materials used besides the LV spindle set were a thermostatable water bath, a thermometer 0-100° C. (scale graduations 1° C. or less) and a time measuring device (scale values not greater than 0.1 seconds). For the measurement, 100 ml of the sample were poured into a wide-neck flask; heated and measured without air bubbles after a prior calibration was carried out. To determine the viscosity, the viscosimeter was positioned relative to the sample such that the spindle dips into the product as far as the mark. The measurement is triggered with the help of the start button, it being ensured that the measurement was carried out in the favourable measuring range of 50% (+/−20%) of the maximum measurable torque. The result of the measurement was given on the display of the viscosimeter in mPas, division by the density (g/ml) giving the viscosity in mm²/s.

Determination of the SiH Content

The determinations of the SiH values of the hydrogen siloxanes used but also that of the reaction matrices are carried out in each case gas-volumetrically by means of the sodium butylate-induced decomposition of aliquot weighed-in sample amounts in a gas burette. Used in the general gas equation, the measured hydrogen volumes permit the determination of the content of active SiH functions in the starting materials but also in the reaction mixtures and thus permit conversion control.

Determination of the Content C—C Multiple Bonds

The content of C—C multiple bonds can be ascertained for example by determining the iodine value. A customary method is determining the iodine value in accordance with Hanus (method DGF C-V 11 a (53) of the Deutsche Gesellschaft für Fetnvissenschaft e.V.). The values given below are based on this method.

Determination of the Number of Hydroxy Groups (OH Value)

The content of OH groups can be determined for example by the method of acetylation with subsequent back-titration of the excess acid (method DGF C-V 17a of the Deutsche Gesellschaft für Fettwissenschaft e.V.). The values given below are based on this method.

Determination of the Molar Mass Distributions:

The gel permeation chromatographic analyses (GPC) were carried out on an instrument model 1100 from Hewlett-Packard using a SDV column combination (100/10 000 Å, each 65 cm, internal diameter 0.8 cm, temperature 30° C.), THF as mobile phase with a flow rate of 1 ml/min and a RI detector (Hewlett-Packard). The system was calibrated against a polystyrene standard in the range from 162-2 520 000 g/mol.

Frit Test

The so-called frit test is a method for determining the effectiveness of antifoam concentrates or antifoam emulsions. Here, in a glass cylinder, a defined amount of air is passed through a surfactant solution in order to produce a constant amount of foam per time unit. This foam is to be disturbed by adding an antifoam and the further formation of the foam is to be prevented. Such a typical test requires: measuring cylinder (100 ml), glass cylinder without foot (2000 ml), foot for glass cylinder, measuring flask (1000 ml), frit with extension of the porosity 1, aquarium pump, rotameter, pipette (10-1000 μl) with pipette tips, spatula, magnetic stirrer with stirring core, surfactant solution and water (dist.). The procedure is carried out by passing air in a defined amount through the surfactant solution by means of a glass frit placed in the glass cylinder. The antifoam is metered in prior to the start of the determination and in each case when 1000 ml of foam is produced. The time for each dosing is noted. The number and the volume of the antifoam dosings within the entire test period are added up and thus form the total consumption of the antifoam. A schematic design of an apparatus for carrying out the frit test is shown in FIG. 1.

Droplet Size:

The size distribution of the prepared emulsions/dispersions was determined by means of static laser diffraction on a measuring device LS320 from Beckman-Coulter.

Materials:

| Material | | Supplier |
|---|---|---|
| Decamethylcyclopentasiloxane | D₅ | ABCR (Cat. No. AB111012) |
| Octamethylcyclotetrasiloxane | D₄ | ABCR (Cat. No. AB111277) |
| Lateral hydrogen siloxane | Me₃SiO[SiMeHO]ₙSiMe₃ | ABCR (Cat. No. HMS-993) |
| Trifluoromethanesulphonic acid | TFMSA | Aldrich (Cat. No. 347817) |
| Solvesso 150 (aliphatic solvent) | | Exxon Mobil Corporation |
| Hostapur SAS | | Clariant, Frankfurt a.M. |
| Marlon A 315 | | Sasol Germany GmbH, |
| | | Hamburg |
| Synperonic PE/F 108 | | Croda GmbH, Nettetal |
| Allyl polyether 1 | Iodine value = | |
| | 13.5 g/100 g, OHV = | |
| | 35 mg KOH/g, 90% by | |
| | weight PO | |
| Allyl polyether 2 | Iodine value = | |
| | 18.5 g/100 g, OHV = | |
| | 44 mg KOH/g, 23% by | |
| | weight PO | |
| Divinyltetrammethyldisiloxane | ^{Vi}MM^{Vi} | ABCR (Cat. No. AB121873) |
| Polymethylphenylsiloxane (500 cSt) | | ABCR (Article PMM-0025) |
| Sodium hydrogencarbonate | | Aldrich (Cat. No. S6297) |

The Karstedt solutions used are platinum(0)-divinyltetramethyldisiloxane complexes in decamethylcyclopentasiloxane in the concentration of 0.1% by weight platinum (available from Umicore with 21.37% by weight of platinum, which is adjusted to 0.1% by weight of Pt by dilution with decamethylcyclopentasiloxane). The dosages of the catalyst given in the examples below refer to the mass total of the initial weights of the reaction components of the hydrosilylation, added solvents are not taken into consideration in this calculation.

### Example 1

### Preparation of the Compositions According to the Invention

### Synthese Example E1

In a multi-neck flask equipped with a stirring device, nitrogen line and reflux condenser, 48.4 g of tetramethyldivinyldisiloxane (^{Vi}MM^{Vi}), 96.9 g of a multilateral hydrogen siloxane (15.7 eq SiH/kg) of the general formula Me₃SiO[SiMeHO]₄₄SiMe₃ (CAS: 63148-57-2, obtainable for example from ABCR), 441.6 g of decamethylcyclopentasiloxane (Dₛ) and 0.35 ml of TFMSA were introduced and stirred for 24 hours at room temperature. After complete equilibration, the mixture was neutralized by adding 11.7 g of sodium hydrogencarbonate within 2 hours and subsequently filtered. From the resulting colourless clear silicone equilibrate, a fraction of 0.256% SiH was determined.

### Synthesis Example E2

In a multi-neck flask equipped with stirring device, nitrogen line and reflux condenser, 6.22 g of tetramethyldivinyldisiloxane, 1.74 g of a multilateral hydrogen siloxane (1.58% SiH), 389.6 g of octamethylcyclotetrasiloxane and 0.4 ml of TFMSA were introduced and stirred for 24 hours at room temperature. After complete equilibration, the mixture was neutralized by adding 8.0 g of sodium hydrogencarbonate within 2 hours and subsequently filtered. A colourless, clear silicone equilibrate was obtained.

### Synthesis Example E3

In a multi-neck flask equipped with stirring device, nitrogen line and reflux condenser, 3.1 g of divinyltetrammethyldisiloxane, 0.98 g of a multi mid-position hydrogen siloxane (15.7 eq/kg SiH), 194.7 g of decamethylcyclopentasiloxane (D₅, ABCR) and 0.12 ml of TFMSA were introduced and stirred for 24 hours at room temperature. After complete equilibration, the mixture was neutralized by adding 4.0 g of sodium hydrogencarbonate within 2 hours and subsequently filtered. A colourless, clear silicone equilibrate was obtained.

### Synthesis Example E1

In a multi-neck flask equipped with stirring device, nitrogen line and reflux condenser, 13.33 g of a multi mid-position hydrogen siloxane (15.7 eq/kg SiH), 65.05 g of D₅, 21.6 g of a polymethylphenylsiloxane (500 cSt, ABCR) and 0.1 ml of trifluoromethanesulphonic acid (Aldrich) were initially introduced and stirred for 24 hours at room temperature. After complete equilibration, the mixture was neutralized by adding 6.0 g of sodium hydrogencarbonate within 2 hours and subsequently filtered. A colourless, clear silicone equilibrate was obtained.

### Synthesis Example S1

In a beaker, 500 ml Synperonic PE F 108 were introduced and stirred using a Dispermat (Mizer disc, diameter 4 cm) at 1000 rpm. With continuing shearing, 313.8 g of water were added in portions within 10 minutes. Shearing for a further 2 hours at 1000 rpm resulted in a clear solution. In a separate vessel, 79.8 g of allyl polyether 1, 24.8 g of a mid-position hydrogen siloxane (1.27 eq SiH/kg) and 4.89 g of the siloxane E3 were converted to a finely divided emulsion at 500 rpm using a precision-ground glass stirrer. 46 g of this emulsion were then introduced into a further vessel, heated to 70° C. and likewise 46 g of the emulsifier solution prepared at the start were homogenized under shear using a Dispermat (1000 rpm, Mizer disc, diameter 4 cm) within 30 minutes. 46 μl of a Karstedt catalyst preparation (1% PT) were then added to this mixture and the hydrosilylation reaction was initiated. After 1 hour, free SiH could no longer be detected gas volumetrically. Cooling to room temperature gave a white paste.

### Synthesis Example S2

In a multi-neck flask with nitrogen line, stirring device and internal thermometer, 46.2 g of allyl polyether 1 (30 mol % excess) and 17.5 g of a mid-position hydrogen siloxane (1.27 eq SiH/kg) and 1.24 g of E3 were introduced and heated to 90° C. The addition of 32 μl of a Karstedt catalyst preparation (1% Pt) initiates the hydrosilylation reaction. After 5 hours, no SiH could be found gas volumetrically. The product was clear and exhibited a viscosity of 1200 mPas/s (Brookfield, spindle 2, 12 rpm). GPC analysis (THF) revealed a molar mass distribution of Mn=5300 g/mol and Mw=28 500 (PDI=5.34).

### Synthesis Example S3

9.06 g of an allyl polyether 1 were added to 11.06 g of a solution of Synperonic PE F 108 (10% by weight in water) and homogenized by means of a stirring device with Mizer disc at 1000 rpm for ca. 5 minutes. 1.96 g of E1 equilibrate were added to the resulting, very finely divided emulsion within 5 minutes with constant shear (1000 rpm). The hydrosilylation reaction was continued to the point of complete SiH conversion by adding 10 μl of Karstedt catalyst preparation (1°/Pt) and over 2 hours at 70° C.

### Synthesis Example S4

9.1 g of allyl polyether 1 were homogenized into 25.8 g of a 10% by weight emulsifier solution (Synperonic PE F 108) using a stirring device with Mizer disc at 1000 rpm for ca. 5 minutes. 1.9 g of the equilibrate E1 were added to this emulsion within 5 minutes and emulsified with continuous shearing (1000 rpm). The hydrosilylation reaction was initiated by adding 10 μl of Karstedt catalyst preparation (1% Pt) and continued to the point of complete SiH conversion using a paddle stirrer at 600 rpm over 2 hours at 70° C.

### Synthesis Example S3

In a multi-neck flask with nitrogen line, stirring device and reflux condenser, 12.5 g of E1 and 57.5 g of allyl polyether 1 were introduced and heated to 70° C. After reaching the reaction temperature, 35 μl of Karstedt catalyst preparation (1% Pt) were added. The reaction, accompanied by slight exothermie and a noticeable increase in viscosity, was able to be brought to complete SiH conversion within 1 hour.

### Synthesis Example S6

3.0 grams of TEGO® Alkanol TD6 (isotridecyl alcohol, polyoxyethylene (6) ether, Evonik Goldschmidt GmbH), 2.0 g of Genapol® T800 (tallow fatty alcohol, polyoxyethylene (80) ether, Clariant GmbH) and 5.0 g of water were heated in a 100 ml PE beaker to 60° C. in the oven and stirred using a Dispermat (VMA-Getzmann GmbH) with a dissolver disc (Ø3 cm) at 500 rpm until a homogeneous, viscous solution was formed.

Over the course of 5 minutes, 20.6 g of the vinyl hydrogen siloxane E2 were incorporated dropwise into the paste with stirring at 1000 rpm and at room temperature. The paste was then diluted with 18.6 g of water. This gave the emulsion. Measurement of the drop size before the reaction with the help of a Coulter LS320 instrument gave an average drop diameter of 0.76 μm. The hydrosilylation reaction was initiated by adding 10 ppm of a platinum compound (Karstedt catalyst preparation) and continued to the point of complete SiH conversion using a paddle stirrer at 600 rpm over 2 hours at 70° C. The size determination by means of the Coulter LS320 instrument produced no significant increase in diameter.

### Synthesis Example S7

3.6 grams of TEGO® Alkanol TD6 (isotridecyl alcohol, polyoxyethylene (6) ether, Evonik Goldschmidt GmbH), 2.3 g of Genapol® T800 (tallow fatty alcohol, polyoxyethylene (80) ether, Clariant GmbH) and 23.5 g of water were heated in a 200 ml PE beaker to 60° C. in the oven and stirred using a Dispermat (VMA-Getzmann GmbH) with a dissolver disc (Ø 3 cm) at 500 rpm until a homogeneous, viscous solution was formed. Over the course of 5 minutes, 40.0 g of the vinylhydrogensiloxane E2 were incorporated dropwise into the paste with stirring at 1000 rpm and at room temperature. The paste was then diluted with the remaining 30.6 g of water. This gave the emulsion. Measuring the drop size with the help of a Coulter LS320 instrument produced an average drop diameter of 7.0 μm. The hydrosilylation reaction was initiated by adding 10 ppm of a platinum compound (Karstedt catalyst preparation) and continued to the point of complete SiH conversion using a paddle stirrer at 600 rpm over 2 hours at 70° C. The size determination by means of the Coulter LS320 instrument produced no significant increase in diameter.

### Synthesis Example S 8

In a multi-neck flask with precision-ground glass blade stirrer, reflux condenser, inert gas line and temperature sensor, 14 g of a siloxane of the formula M₁M^{H}₁D₁₂₃D^{H}₂₅T_{D}Q₀ (R¹=Me) with 69.94 g of allyl polyether 2, 2.98 g of a M_{0.04}M^{v}_{1.96}M^{H}₀D_{147.1}D^{H}_{0.9}D^{v}₀T₀Q₀ siloxane (E4) and 20 g of Solvesso 150 were mixed together thoroughly, and the hydrosilylation was initiated under an inert gas atmosphere by adding 10 ppm of platinum in the form of a Karstedt catalyst to the cloudy reaction mixture. The mixture was then heated to a reaction temperature of 80-90° C. and the exothermy was brought under control such that the reaction temperature of 90° C. was not exceeded. After 2.5 hours, free SiH could no longer be detected gas volumetrically. The slightly yellow product exhibited, according to GPC analysis, a molar mass distribution of Mₙ=4744 g/mol and M_{w}=164 457 (M_{w}/Mₙ=34.67) and a viscosity of 3.1 Pa*s.

### Synthesis Example S 9

In a multi-neck flask with precision-ground glass blade stirrer, reflux condenser, inert gas line and temperature sensor, 16.1 g of a siloxane of the formula M₂M^{H}₆D₆₇D^{H}₂₄T₀Q₀ (where R¹=Me or phenyl) which has been prepared in E4 were mixed thoroughly with 59.4 g of allyl polyether 2, 4.4 g of a M₀M^{v}₂M^{H}₀D₃₅₀D^{H}₀D^{v}₀T₀Q₀ (where R¹=Me and R³=—CH₂CH₂) siloxane and also 20 g of Solvesso 150 and heated to a reaction temperature of 80-90° C. under an inert gas atmosphere. After reaching the reaction temperature, the hydrosilylation was initiated by adding 10 ppm of platinum in the form of a Karstedt catalyst to the as yet cloudy reaction mixture. Here, the exothermy was brought under control such that the reaction temperature of 90° C. was not exceeded. After 4.5 hours, free SiH could no longer be found gas volumetrically. The slightly yellow product exhibited, according to GPC analysis (THF), a molar mass distribution of Mₙ=4849 g/mol and M_{w}=78 619 (M_{w}/Mₙ=16.21) and a viscosity of 8.9 Pa*s.

### Synthesis Example S 10

In a multi-neck flask with precision-ground glass stirrer, reflux condenser, inert gas line and temperature sensor, 16.1 g of a siloxane of the formula M₁M^{H}₁D₁₂₃D^{H}₂₅T₀Q₀ (where R¹=Me) were mixed thoroughly with 63.2 g of polyether 2, 2.6 g of a M₀M^{v}₆M^{H}₆D₁₇₆D^{H}₀D^{v}₀T₀Q₅ siloxane (where R¹=Me and R³=—CH₂CH₂) and also 20 g of Solvesso 150 and heated to a reaction temperature of 80° C. under an inert gas atmosphere. After reaching the reaction temperature, the hydrosilylation was initiated by adding 10 ppm of platinum in the form of a Karstedt catalyst to the as yet cloudy reaction mixture. Here, the exothermy was brought under control such that the reaction temperature of 90° C. was not exceeded. After 3 hours, free SiH could no longer be found gas volumetrically. The slightly yellow product exhibited, according to GPC analysis, a molar mass distribution of Mₙ=3886 g/mol and M_{w}=414 335 g/mol (M_{w}/Mₙ=106.63) and a viscosity of 13 Pa*s.

### Synthesis Example S 11

### Not According to the Invention

In a multi-neck flask with nitrogen line, stirring device and internal thermometer, 435.7 g of allyl polyether 1 (40 mol % excess) and 94.3 g of a mid-position hydrogen siloxane (1.82 eq SiH/kg) were introduced and heated to 90° C. The addition of 0.26 ml of a Karstedt catalyst preparation (1% Pt) initiated the hydrosilylation reaction. After 7 hours, no SiH could be found gas volumetrically. The product was clear and exhibited a viscosity of 1212 mPas/s (Brookfield, spindle 2, 12 rpm). The GPC analysis (THF) revealed a molar mass distribution of Mn=5480 g/mol and Mw=24 592 (PDI=4.49).

### Synthesis Example S 12

In a multi-neck flask with nitrogen line, stirring device and internal thermometer, 402.8 g of allyl polyether 1 (40 mol % excess) and 90.8 g of a mid-position hydrogen siloxane (1.82 eq SiH/kg) and 36.4 g of the siloxane equilibrate E3 were introduced and heated to 90° C. The addition of 0.26 ml of a Karstedt catalyst preparation (1% Pt) initiated the hydrosilylation reaction. After 10 hours, no SiH could be found gas volumetrically. The product was slightly cloudy and exhibited a viscosity of 8800 mPas/s (Brookfield, spindle 2). The GPC analysis (THF) revealed a molar mass distribution of Mn=5717 g/mol and Mw=180 155 (PDI=31.51).

### Example 2

### Use of the Compositions According to the Invention for Producing Preparations

a) The emulsification of the preparation described according to synthesis example S11 was carried out in accordance with the method described in EP 1132417 (example 1). The resulting 20% strength by weight antifoam emulsion was used according to example 3 (below) as reference.

b) The emulsification of the preparation described according to synthesis example S 12 was carried out in accordance with the method described in EP 1132417 (example 1). The resulting 20% strength by weight antifoam emulsion was tested according to example 3 (below) against 1a.

### Example 3

### Use of the Compositions According to the Invention from Example 2 as Antifoam

The preparations prepared according to examples 2a and 2b were tested as regards their effectiveness using the frit test described above. Here, two different surfactant solutions (in each case 0.2% by weight in water) were used. The test was carried out at 60° C.

TABLE 1
Total dosage of the antifoam preparation prepared according to
example 2a and example 2b after 60 minutes at a temperature
of 60° C. using two different surfactant systems.

| | Total dosage [μl] - | Total dosage [μl] - |
|---|---|---|
| Product | surfactant system 1 | surfactant system 2: |
| Example 2 a | 1100 | 300 |
| Example 2 b | 120 | 80 |
| Reduction to [% by volume] | 10.9 | 26.7 |

Surfactant system 1: Hostapur SAS, (60° C., 0.2% by weight),
Surfactant system 2: Marlon A 315, (60° C., 0.2% by weight)

The volumes required for foam reduction were considerably reduced for the samples of example 2b; for example, in example 2b/surfactant 1, merely 120 μl of the antifoam preparation according to example 2b sufficed in order to achieve the same effect as the preparation not according to the invention in accordance with example 2a (1100 μl). This corresponds to a reduction to 10.9% based on the volume of the antifoam preparation used. The antifoam test clearly shows that the (self-crosslinked) siloxanes according to the invention defoam significantly better than the (uncrosslinked) structures not according to the invention.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A composition comprising:
a component A; and
a component D;
wherein component A comprises a polymer obtained by reaction in the sense of a hydrosilylation of one compound of the formula (I) with another compound of the formula (I) and/or with compounds C which have a C—C multiple bond and do not correspond to formula (I);
wherein the formula (I) is:
MₐM^{v}_{b}M^{H}_{c}D_{d}D^{H}ₑD^{v}_{f}T_{g}Qₕ formula (I);
where:
M=[R¹₃SiO_{1/2}];
M^{V}=[R³R¹₂SiO_{1/2}];
M^{H}=[R¹₂SiHO_{1/2}];
D=[R¹₂SiO_{2/2}];
D^{H}=[R¹SiHO_{2/2}];
D^{V}=[R³R¹SiO_{2/2}];
T=[R¹SiO_{3/2}];
Q=[SiO_{4/2}];
a=0 to 42;
b=0 to 42;
c=0 to 42;
d=5 to 600;
e=0 to 50;
f=0 to 50;
g=0 to 20;
h=0 to 20;
with the proviso that the following conditions are satisfied:
a+b+c is greater than or equal to 2;
b+f is greater than 0;
c+c is greater than 0 and 0.24*(a+b+c+d+e+f+g) is greater than (c+e);
where:
R¹ independently of one another are identical or different alkyl radicals having 1 to 30 carbon atoms, or identical or different aryl radicals having 6 to 30 carbon atoms or —OH or —OR²;
R² independently of one another are identical or different alkyl radicals having 1 to 12 carbon atoms, or identical or different aryl radicals having 6 to 12 carbon atoms;
R³ independently of one another are identical or different organic radicals having a terminal C—C double bond or a terminal or internal C—C triple bond; and
wherein component D is metal atoms or ions of the platinum group.

2. A composition according to claim 1;
wherein the component A has a polymer obtained by reaction in the sense of a hydrosilylation of compounds of the formula (I) and compounds of the formula (II);
wherein the formula (II) is:
MᵢM^{H}ᵢDₖD^{H}ₗTₘQₙ formula (II);
where:
i=0 to 34;
j=0 to 34;
k=5 to 600;
l=0 to 50;
m=0 to 16;
n=0 to 16;
i+j is greater than or equal to 2; and
j+l is greater than or equal to 2.

3. The composition according to claim 1;
wherein the component A comprises a polymer obtained by reaction in the sense of a hydrosilylation of compounds of the formula (I) with one or more unsaturated compounds C.

4. The composition according to at least one of claim 2;
wherein the component A comprises a polymer obtained by reaction in the sense of a hydrosilylation of compounds of the formula (I) with a compound of the formula (II) and one or more unsaturated compounds C.

5. The composition according to claim 1, further comprising:
a component B obtained by reaction in the sense of a hydrosilylation of compounds of the formula (II) with unsaturated compounds C;
wherein the formula (II) is;
MᵢM^{H}ⱼDₖD^{H}ᵢTₘQₙ formula (II);
where:
i=0 to 34;
j=0 to 34;
k=5 to 600;
l=0 to 50;
m=0 to 16;
n=0 to 16;
i+j is greater than or equal to 2, and
j+l is greater than or equal to 2.

6. The composition according to claim 1, further comprising:
one or more compounds C.

7. The composition according to claim 1;
wherein the compounds C are polyethers of the formula (III):
CH₂═CHCH₂O(C₂H₄O)ₒ(C₂H₃(CH₃)O)ₚ(C₂H₃(C₂H₅)O)_{q}(C₂H₃(Ph)O)ᵣR⁴ formula (III);
where:
R⁴ independently of one another are identical or different organic radicals which carry no multiple bond accessible to the hydrosilylation;
o=0 to 200;
p=0 to 200;
q=0 or greater than 0 to 100;
r=−0 or greater than 0 to 100; and
when o+p+q+r is greater than 3, preferably p is greater than 0.

8. The composition according to claim 1;
optionally further comprising a component B obtained by reaction in the sense of a hydrosilylation of compounds of the formula (II) with unsaturated compounds C;
wherein the formula (II) is:
MᵢM^{H}ⱼDₖD^{H}ₗTₘQₙ formula (II)
where:
i=0 to 34;
j=0 to 34;
k=5 to 600;
l=0 to 50;
m=0 to 16;
n=0 to 16;
i+j is greater than or equal to 2; and
j+l is greater than or equal to 2;
wherein the component A is present in an amount of 1 to 90% by mass of the total composition;
wherein the component B is present in an amount of 0 to 70% by mass of the total composition;
wherein the compounds C are present in an amount of 0 to 95% by mass of the total composition; and
wherein the component D is present in an amount greater than 0 to no more than 50 ppm by mass of the total composition.

9. The composition according to claim 8,
wherein the component A is present in an amount of 1 to 15% by mass of the total composition;
wherein the component B is present in an amount of from 1 to 30% by mass of the total composition;
wherein the compounds C is present in an amount of from 10 to less than 90% by mass of the total composition; and

10. The composition according claim 1;
wherein the component A is present to more than 90% by weight, based on the components A, polymers with a weight-average molar mass of less than 2,500,000 g/mol; and
wherein the component B is present to more than 90% by weight, based on the component B with a weight-average molar mass of up to 1,000,000 g/mol and is present in the composition with less than 5% by weight, based on the total composition.

11. The composition according to claim 1;
wherein the composition is liquid at 20° C. and 1013 mbar.

12. The composition according to claim 1, further comprising:
water and/or an emulsifier.

13. The composition according to claim 1;
wherein the composition has a viscosity of less than 100 Pa*s.

14. A process for the preparation of a composition according to claim 1, comprising:
reacting at least one compound of the formula (I) with another compound of the formula (I) and/or with compounds C which have a C—C multiple bond and do not correspond to formula (I) under hydrosilylating conditions and in the presence of a catalyst catalysing the hydrosilylation.

15. The process according to claim 14;
wherein at least one compound of the formula (I) and at least one compound of the formula (II) is reacted with at least one unsaturated compound C which contains or or more C—C multiple bonds under hydrosilylating conditions; and
wherein the formula (II) is:
MᵢM^{H}ⱼDₖD^{H}ₗTₘQₙ formula (II);
where:
i=0 to 34;
j=0 to 34;
k=5 to 600;
l=0 to 50;
m=0 to 16;
n=0 to 16;
i+j is greater than or equal to 2; and
j+l is greater than or equal to 2.

16. The process according to claim 14;
wherein the hydrosilylating reaction is carried out with the addition of water, optionally solvent; and optionally with the addition of emulsifiers.

17. The process according to claim 14
wherein the reaction components are supplied to a reaction vessel, with the proviso that, prior to starting to add the catalyst, at least one aliquot of the compound of the formula (I) or at least one aliquot of a mixture comprising the compound (II) and an unsaturated compound C are present in the reaction mixture in the reaction vessel; and
wherein the formula (II) is:
MᵢM^{H}ⱼDₖD^{H}ₗTₘQₙ formula (II);
where:
i=0 to 34;
j=0 to 34;
k=5 to 600;
l=0 to 50;
m=0 to 16;
n=0 to 16;
i+j is greater than or equal to 2; and
j+l is greater than or equal to 2.

18. A method for producing an antifoam, comprising:
utilizing the composition according to claim 1 to produce an antifoam.

19. A method comprising:
utilizing the composition according to claim 1 as an antifoam for a liquid.
